(19) United States
(12) Patent Application Publication
(10) Pub. No.: US 2025/0061710 A1
(43) Pub. Date: Feb. 20, 2025

(54) LOCAL AI INFERENCE

(71) Applicant: SkyBell Technologies IP, LLC, Irvine, CA (US)

(72) Inventor: Andrew Weedmark-Kish, Toronto (CA)

(21) Appl. No.: 18/723,241

(22) PCT Filed: Dec. 19, 2022
(86) PCT No.: PCT/US2022/081983

§ 371 Date: Jun. 21, 2024

(51) Int. Cl. G06V 20/40; G06V 10/70; G06V 40/16

(52) U.S. Cl. CPC G06V 20/41; G06V 10/70; G06V 40/172

(57) ABSTRACT

Artificial Intelligence (AI) is used to infer information from a live video/audio feed from a doorbell camera, surveillance camera, and the like. Moving such capability from the Cloud or the Edge may provide a cost advantage, greater assurance of privacy concerning a surveilled location, and less latency than other methods employing Al inference.

Artificial intelligence (AI) may be used to identify people, packages, or situations requiring attention. Much hardware and software may be devoted to analyzing video data insofar as facial 6 recognition, etc., is concerned. Typically, such functionality is performed on a large scale through and on a network. However, given the ever-increasing capabilities of computing devices, a need exists to provide AI information processing at a local level.

### BRIEF DESCRIPTION OF THE DRAWINGS

Features, aspects, and advantages are described below with reference to the drawings, which are intended to illustrate, but not to limit, the invention. In the drawings, like reference characters denote corresponding features consistently throughout similar embodiments.

FIG. 1 illustrates a diagram of a doorbell system showing a doorbell/surveillance camera on a door at a house.

FIG. 2 illustrates a diagram depicting a use scenario involving a doorbell/surveillance camera system.

FIG. 3 illustrates a call processing diagram in connection with a live video call.

FIG. 4 illustrates a call processing flow in connection with Pocket Inference.

FIG. 5 illustrates a diagram of a doorbell or surveillance camera connected to a home that is in communication with a mobile computing device having an AI inference engine (e.g., a neural processor) along with computer memory.

FIG. 6 is a flowchart illustrating process flow where metadata (for AI Inference as determined by a neural processor on a mobile computing device) is stored on the mobile computing device.

FIG. 7 illustrates a block diagram showing a mobile computing device with an AI inference engine wherein storage of AI inference metadata related to doorbell data is stored locally at the mobile computing device.

FIG. 8 is a flowchart illustrating the process flow where metadata, as determined by a neural processor using AI inference on a mobile computing device, is stored remotely from a mobile computing device.

### DETAILED DESCRIPTION

Mobile computing devices, such as smartphones, contain an artificial intelligence engine that may be used, which would otherwise represent unused or under-utilized computing power.

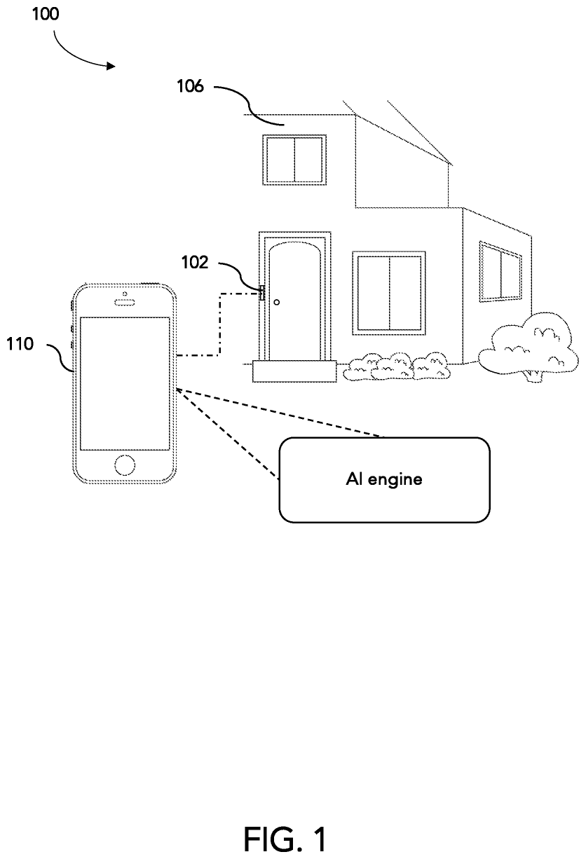

FIG. 1 illustrates a doorbell/surveillance camera system 100 showing doorbell camera 102 on door 104 at house 106. AI engine 108 is contained in smartphone 110.

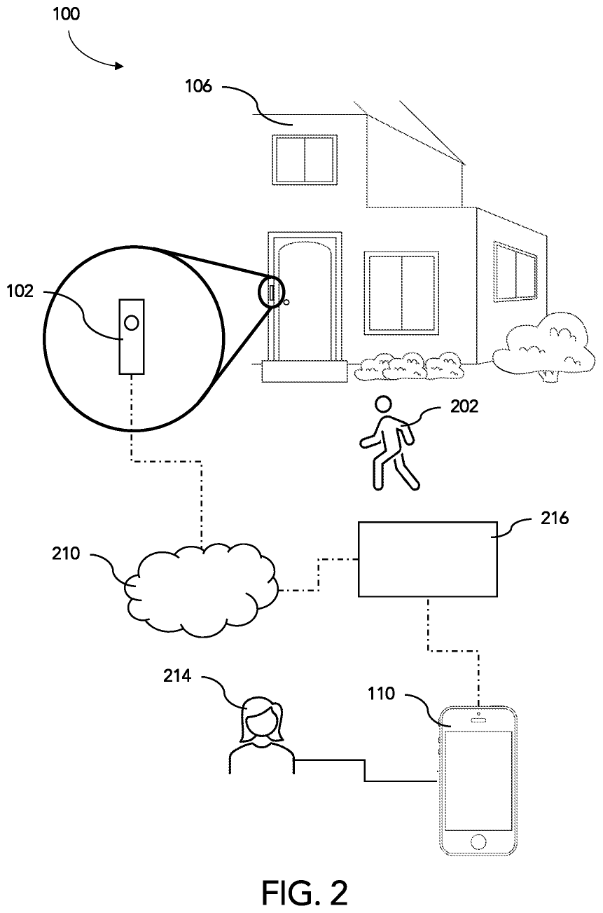

FIG. 2 illustrates a diagram depicting a use scenario involving the doorbell/surveillance camera system of FIG. 1. Delivery person 202 brings package 204 to house 106. Camera 102, which may be a doorbell camera or a surveillance camera, captures one or more images with or without audio of delivery person 202 approaching house 106. The delivery data from delivery person 202 is delivered to network 210, as is data from camera 102. Network 210 may stream the delivery event data to smartphone 110 of user 214, directly to smartphone 110, or through a delivery information system 216.

Artificial intelligence may be used to identify people and things connected to a doorbell camera and/or surveillance camera. Further, there are the paradigms of Cloud and Edge (Cloud referring to on-demand computer system resources and Edge referring to distributed data storage and processing of information near a source of data), used with processing video information.

In the case of streaming video, using inference, things may be inferred from video and/or audio information using artificial intelligence (AI). AI inference may also be referred to as computer vision or machine learning, and there are well-known ways to accomplish it. More specifically, a neural processor may use a doorbell camera and/or surveillance camera video and/or audio data to infer certain things about that data. The AI inference may inform whether any faces or human bodies or packages or pets are present in recorded camera image(s) or identified in recorded audio. Further, the AI inference may be used in theft situations where, for example, a package is stolen from a residence, etc. The resulting inference information may be reported back to a user through the Cloud on their mobile device. A relatively long amount of time elapses between getting a live call to receiving metadata about that live call. For instance, the inference may identify a person, a package, a type of vehicle, etc.

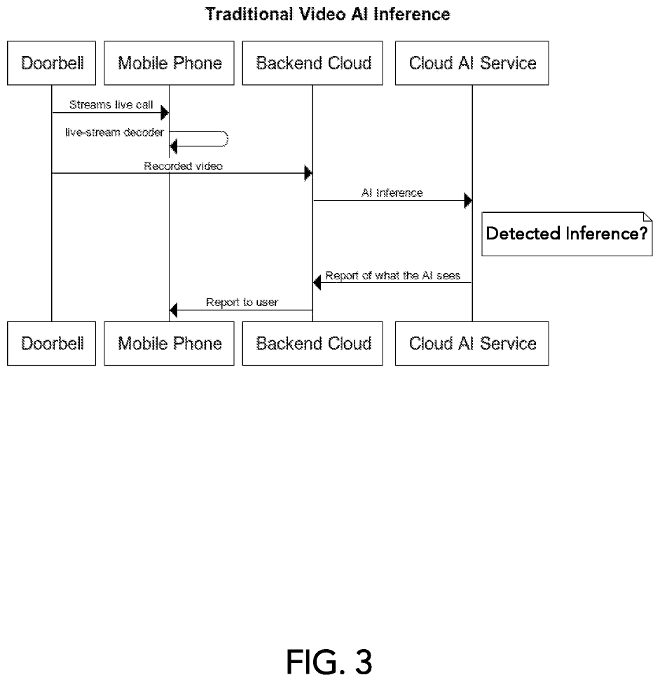

In some cases, Cloud computing may perform the AI inference. FIG. 3 illustrates a call processing diagram in connection with a live video call. With reference to FIG. 3, an image or video from a surveillance or doorbell camera may be streamed, during a live call, to a mobile computing device, such as a smartphone, for decoding by a live stream decoder (not shown) and for display on a screen (not shown). While this streamed information is generally disposed of afterward, a second feed of this information may be recorded in the Cloud (denoted as the Backend Cloud). That information may be sent to an artificial intelligence service (Cloud AI Service) where processing in the Cloud may make inferences (as to who, what, where, etc., are presented in the stream) from the data should an inference be detected. That inference information is reported back to the Cloud (for storage in the Backend Cloud), and it may be forwarded to the mobile computing device as, for instance, metadata. More specifically, in the Cloud, using tools such as “SageMaker”™ (offered through Amazon Web Services™ (AWS)), there are ways, at the Edge, to infer information from video by using libraries that chip vendors typically provide for running analysis on a video stream. That inference may answer a question concerning a video or image, such as the following: Is there a person there? Is there a package there? Is there a car there?

Beyond the paradigms of Cloud and Edge, there is the Fog. The Fog refers to devices that are connected to the Edge. Instead of making inferences at the Cloud or on the Edge, inferences may be determined locally on a mobile phone (e.g., in the Fog or at the “Far” Edge). Smartphones now typically contain neural processors, and that resource may be used advantageously in connection with artificial intelligence programs used to identify objects, events, etc. Using the neural processor that may already exist in a phone also dispenses with having to place such capability at the doorbell location. Newer phones, in particular, are being sold with neural processors that are positioned near regular general-purpose processors.

Further, processing capability is more likely to be upgraded at the mobile phone than upgrading doorbell processing hardware. AI inference at the mobile computing device will be referred to herein as “In the Pocket,” the Pocket representing a place where a mobile phone May be typically found. Making these inference determinations locally at a mobile computing device provides an advantage. For instance, a mobile phone likely has much higher processing power than that available at the Edge and because its use probably involves less latency than the Cloud. Further, processing In the Pocket (i.e., in the Fog) is cheaper to use than processing in the Cloud because every time a function is used in the Cloud, that incurs a fee. By comparison, a mobile phone providing similar functionality would not incur a processing fee.

Further, there may be an advantage in connection with real-time latency since a mobile phone may be close to a device for which AI inference is required. Accordingly, a mobile phone may be connected directly to such a device (e.g., a doorbell camera) through a local area network such as Wi-Fi instead of over the Internet at large. Even in instances where a mobile phone is very remote from a device and communicating over the Internet at large, although In the Pocket inference may not necessarily offer an advantage in latency over Cloud or Edge inference, its advantage in cost remains.

An additional advantage of performing AI inference in the Fog is that Pocket Inference provides privacy assurance that doesn't require reliance on the word of a service provider, etc. For instance, Cloud providers may claim that users can trust them not to divulge personal information, e.g., showing a video to others who come to a front door, etc. Further, they may make claims such as, “We're not going to look at your information.” With pocket inference, such trust is unnecessary as that video will not lie in the Cloud since Pocket Inference doesn't allow a Cloud provider to see a copy of the surveillance images or video.

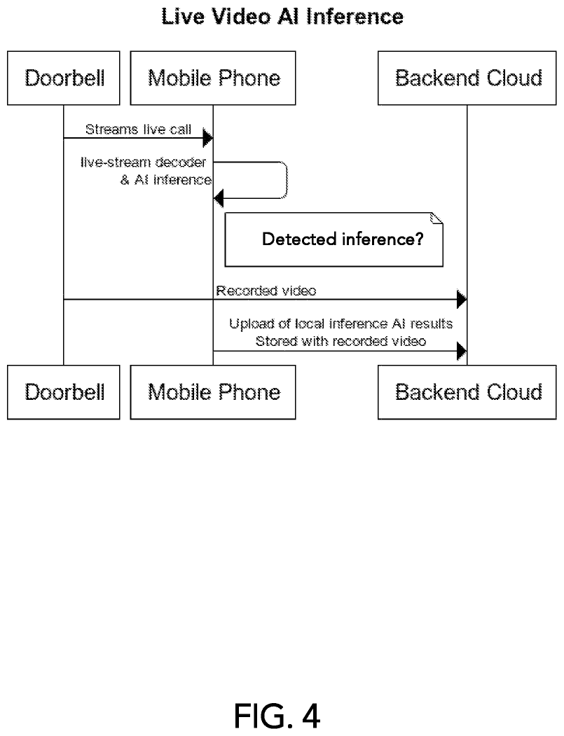

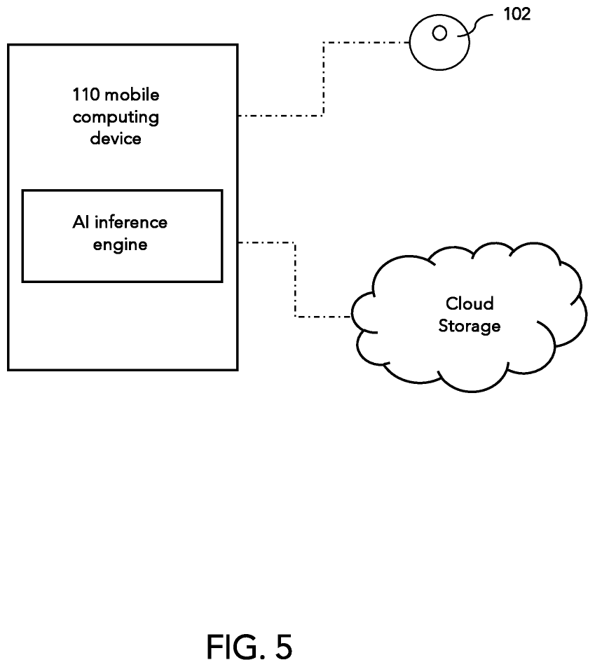

FIG. 4 illustrates a call processing flow in connection with Pocketer Inference. FIG. 5 shows a diagram of a doorbell or surveillance camera connected to a home that is in communication with a mobile computing device having an AI inference engine (e.g., a neural processor) along with computer memory. As shown in FIG. 4, video and or audio data from a doorbell camera or a surveillance camera is streamed to a mobile computing device in connection with a doorbell system. A decoder decodes that information to display an image(s) on the mobile computing device. In addition, in connection with software running on a neural processor of the mobile computing device, AI Inference information from the streamed data is processed. Live stream decoding and AI inference may coincide. In summary, a video frame is decoded from a live call. In addition to the display of a frame, but before it is dispensed with, the frame is processed, in the background, by a neural processor using inference. The metadata from the doorbell system (including the doorbell camera and/or other surveillance camera(s) may be stored (as shown in FIGS. 4 and 5) in the Cloud (noted as the Backend Cloud). Alternatively, metadata may be stored locally on a mobile computing device.

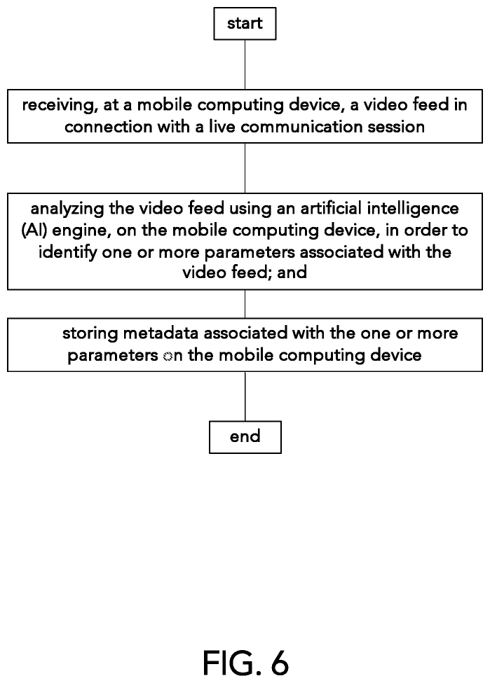

FIG. 6 is a flowchart illustrating the process flow where metadata (for AI Inference as determined by a neural processor on a mobile computing device) is stored on a mobile computing device.

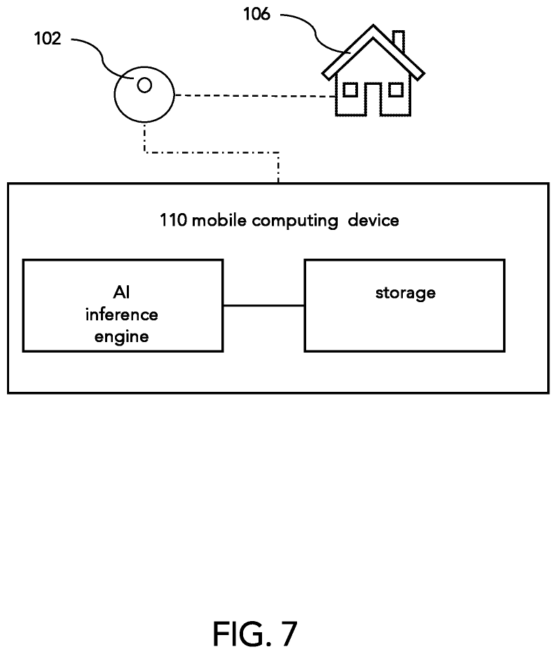

FIG. 7 illustrates a block diagram showing a mobile computing device with an AI inference engine wherein storage of AI inference metadata related to doorbell data is stored locally at the mobile computing device.

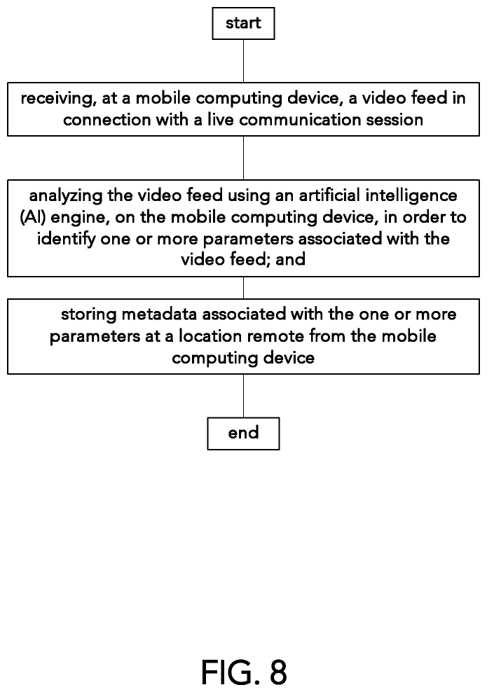

FIG. 8 is a flowchart illustrating the process flow where metadata, as determined by a neural processor using AI inference on a mobile computing device, is stored remotely from a mobile computing device.

Distributed computing may also be used with the AI inference performed on a mobile computing device. Consequently, two or more devices may be used to perform a required AI inference. For instance, AI engine capability may be borrowed from a mobile phone in a network in connection with a blockchain detailing such an occurrence for accounting, billing, awarding credit among participating smartphone owners, etc. Further, it is contemplated that older smartphones without a neural processor may borrow the neural processing capability of another smartphone. In addition, the AI inference duties may be shared between a mobile device and, for instance, a personal computer, tablet, etc. In other words, the AI inference task may be off-loaded to another device or a private server (or somewhere close to the Edge) under the doorbell system owner's control. The application herein applies not only to video that streams in real-time but also to audio. Many Internet of Things (IoT) applications concern sending telemetry data up to the Cloud, where it gets processed (in connection with decision making and drawing inferences). This can be done at the Edge or in the Fog. Many Open Source libraries are available concerning computer vision and analysis that may be downloaded to a mobile computing device, such as a smartphone, and used there.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are non-limiting. The section headings and subheadings do not represent or limit the full scope of the embodiments described in the sections to which the headings and subheadings pertain. For example, a section titled “Topic 1” may include embodiments that do not pertain to Topic 1, and embodiments described in other sections may apply to and be combined with embodiments described within the “Topic 1” section.

The various features and processes described above may be used independently or combined in various ways. All possible combinations and sub-combinations are intended to fall within the scope of this disclosure. In addition, certain methods, events, states, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A method, comprising:
receiving, through a mobile computing device, a feed selected from the group consisting of a video feed, an audio feed, and a combination thereof, wherein the video feed and the audio feed occur in connection with a live communication session;
analyzing the video feed using an artificial intelligence (AI) engine on the mobile computing device to identify one or more parameters associated with the video feed; and
storing metadata associated with the one or more parameters.

2. The method of claim 1, wherein the metadata associated with the one or more parameters is stored in the mobile computing device.

3. The method of claim 1, wherein the metadata associated with the one or more parameters is stored at a location remote from the mobile computing device.

4. The method of claim 1, wherein the AI engine is configured to identify the one or more parameters using AI inference.

5. The method of claim 4, wherein the one or more parameters are indicative of a human being.

6. The method of claim 4, wherein the one or more parameters are indicative of motion.

7. The method of claim 4, wherein the one or more parameters are indicative of a visitor's presence.

8. The method of claim 4, wherein the one or more parameters are indicative of facial recognition data.

9. The method of claim 4, wherein the one or more parameters are indicative of one or more audible sounds.

10. The method of claim 4, wherein the one or more parameters are indicative of a parcel delivery or a parcel theft.

11. A system, comprising:
a video camera;
a computer-readable, non-transitory, programmable product, comprising code, executable by a processor, in a mobile computing device, to cause the processor to identify one or more parameters associated with a video feed from the video camera; and
memory configured to receive metadata associated with the one or more parameters.

12. The system of claim 11, wherein the one or more parameters are selected from the group consisting of a human being, motion, a visitor's presence, facial recognition data, one or more audible sounds, and a parcel delivery.

13. The system of claim 11, wherein the memory is located in the mobile computing device.

14. The system of claim 11, wherein the memory is part of cloud storage remotely located from the mobile computing device.

15. The system of claim 11, wherein the processor is configured to identify the one or more parameters associated with the video feed using AI inference.

16. The system of claim 11, wherein the video camera is selected from the group consisting of a doorbell camera and a standalone camera.

17. (canceled)

18. The system of claim 11, wherein the video feed is a live video feed.

19. A computer-readable, non-transitory, programmable product, comprising code, executable by a processor, for causing the processor to analyze a video feed using an artificial intelligence (AI) engine on a mobile computing device, to identify one or more parameters associated with the video feed, the code further causing the processor to receive the video feed from a video camera located remotely from the mobile computing device.

20. The computer-readable, non-transitory, programmable product of claim 18, wherein the code additionally causes the processor to identify metadata associated with the one or more parameters.

21. The computer-readable, non-transitory, programmable product of claim 18, wherein the one or more parameters are indicative of a human being.
